(19) United States
(12) Patent Application Publication
(10) Pub. No.: US 2025/0135443 A1
(43) Pub. Date: May 1, 2025

(54) ACID CONDENSATION CATALYSTS

(71) Applicants: Johnson Matthey Public Limited Company, London (GB); Virent, Inc., Madison, WI (US)

(72) Inventors: Leighta Johnson, Madison, WI (US); Edgar Steenwinkel, Madison, WI (US); Stephen John Schuyten, Savannah, GA (US)

(21) Appl. No.: 18/926,163

(22) Filed: Oct. 24, 2024

Related U.S. Application Data
(60) Provisional application No. 63/593,779, filed on Oct. 27, 2023.

(30) Foreign Application Priority Data
Dec. 6, 2023 (GB) 2318628.1

(51) Int. Cl. B01J 29/40; B01J 23/755; B01J 35/63; B01J 35/64; B01J 37/02; B01J 37/08

(52) U.S. Cl. CPC B01J 29/40; B01J 23/755; B01J 35/633; B01J 35/635; B01J 35/638; B01J 35/643; B01J 37/0201; B01J 37/082; B01J 2523/31; B01J 2523/847

(57) ABSTRACT

The specification describes an acid condensation catalyst comprising: a zeolite having a pore size of 10 tetrahedral atoms, a porosity of ≥0.05 mL/g in the range of 20-100 Å, and a silica: alumina ratio (SAR) of 10 to 50; an alumina binder in which the zeolite is dispersed; and at least one metal; wherein the acid condensation catalyst has a porosity of ≥0.06 mL/g in the range of 20-100 Å as measured by physisorption using the BJH method. Also described is a method for preparing the catalyst, and a process of carrying out acid condensation on a feed stream comprising one or more oxygenated compounds, which is carried out in the presence of a catalyst as described.

### TECHNICAL FIELD

The present invention relates to catalysts for carrying out acid catalysed condensation of an oxygenated feedstock to yield aromatic products.

### BACKGROUND ART

There is an urgent need to find alternatives to fossil fuels due to the negative impact of fossil fuels on the environment. One approach is to produce fuels from biomass, which unlike fossil fuels, is renewable. To this end, Virent Energy Systems Inc. have developed a process for converting biomass into fuel grade material (BioForming™ technology). BioForming™ technology has been extensively described in, for instance, U.S. Pat. No. 7,977,517 (Virent Energy Systems, Inc.) and US2016/108330A1 (Virent, Inc.). This process comprises three steps. Firstly, a feed comprising sugars and/or cellulosic biomass is hydrogenated to provide a material comprising polyols. Secondly, the material comprising polyols is subject to hydrodeoxygenation to provide a stream comprising unsaturated compounds. Thirdly, the material comprising unsaturated compounds is subject to an acid condensation step to yield various products including aromatic compounds.

In U.S. Pat. No. 7,977,517B2 and US2016/108330A1 the acid condensation step (AC step) is carried out in the presence of a catalyst having acid sites (AC catalyst). A wide variety of catalysts are suggested, including zeolites, silica-alumina phosphates, aluminium phosphates, amorphous silica alumina, zirconia, sulphated zirconia. Exemplified zeolite catalysts include La-doped H-mordenite, Ni-doped H-mordenite, Eu-doped H-mordenite, Ga-doped beta zeolite, phosphoric acid doped SiO₂/Al₂O₃, Ni-doped Al₂O₃-bound ZSM-5 and Ga-doped Al₂O₃-bound ZSM-5 (Examples 38-44, both references). The catalysts were tested in vapor-phase condensation of various oxygenate feeds.

Further examples of catalysts for acid condensation step are described in U.S. Pat. No. 9,878,966B2. In one example the catalyst comprises 1 wt % Ni on a commercially available Al₂O₃-bound ZSM-5 support ( 1/16″ extrudates, 20% Al₂O₃ binder, ZSM-5 SAT 30, Zeolyst).

Another example of a process of converting alkenes or alkanes into aromatics is described in US2022/0203343A1. The catalyst comprises a microporous zeotype, a binder and a metal phosphide. The examples in this reference are prepared using the commercial zeolite CBV3024 from Zeolyst, having a SAR of 30.

An unwanted side-product of the acid condensation step is carbon deposits (aka coke). The presence of coke blocks access of the feed molecules to the acid sites of the zeolite, thereby reducing the activity of the catalyst. Some degree of coke formation is inevitable, and coke yield generally correlates with catalyst productivity. In operation it is necessary to carry out catalyst regeneration where the carbon which has built up of the catalyst is burnt off, which requires reactor downtime.

It would be advantageous to provide a catalyst that has a reduced coke yield, and/or greater activity at a given coke yield, which contributes to higher product yield and less regeneration time. The present invention provides a solution to this problem.

### SUMMARY OF THE INVENTION

It has now been established by the present inventors that an AC catalyst comprising a zeolite having a pore size of 10 tetrahedral atoms and an alumina binder is particularly suitable for the AC step. In particular, the present inventors have established that the activity and coke yield of the catalyst can be controlled by selecting the alumina and zeolite to achieve a specific pore size distribution in the catalyst.

The following theory, which has been constructed in hindsight, explains how the porosity of the alumina and zeolite impact on the coking performance of the catalyst.

The catalyst of the invention comprises a zeolite and binder matrix. The role of the binder is to give strength to the catalyst and to prevent it from crumbling in the reactor. The particles of alumina constituting the binder surround the zeolite particles and hold the mixture together.

Small crystals of alumina compared to the size of zeolite particles are desirable to give strength to the catalyst, as small alumina particles can best pack around the larger zeolite particles.

Commerical aluminas are generally agglomerates (referred to herein as “alumina binder precursors”) made up of smaller crystals of aluminium oxide hydroxide called boehmite or pseudo-boehmite. The individual crystals of alumina binder precursors are of the order of 2 to several tens of nanometers. The agglomerates include micro- and/or meso-pores which contribute to the overall micro- and mesoporosity of the final catalyst. The alumina binder precursor is peptized with acid either before or after combining with the zeolite in order to disperse alumina binder precursor individual crystals, and thereby allow them to better pack around the zeolite particles. The peptization and binding process imparts properties to the finished catalyst that are related to the properties of the alumina binder precursors and contribute to the porosity of the catalyst.

Commercial zeolite particles may also be aggregates of smaller zeolite crystals, called polycrystalline agglomerates, with varying degrees of meso- and macroporosity. By contrast with the alumina binder precursor, the zeolite particles are not significantly broken down during peptization (described further below).

The inventors have established that a catalyst having the pore size distribution described herein offers an advantageous balance between catalyst activity and coke yield. The pore size distribution of the catalyst is influenced by the pore size distribution of the zeolite material and the alumina. It is thought that the presence of some meso- and macroporosity within the catalyst allows molecules to approach and exit the channels of the 10 membered ring zeolite particles within the catalyst aggregate. Without sufficient porosity, product molecules are thought to be less able to exit the catalyst, leading to further reaction and the build up of coke.

The zeolite must have a sufficiently high pore volume in the 20-100 Å range to allow feed molecules to reach active sites in the zeolite and to exit the zeolite once conversion has occurred.

The present inventors have also realised that one factor contributing to the deactivation of the catalyst is migration of aluminium from the zeolite to the binder. The aluminium provides acid sites within the zeolite where catalysis takes place. Over time, migration of aluminium from the zeolite results in a reduction in the number of active sites and consequently a drop in activity. The zeolite used in the present invention therefore has a silica: alumina ratio (SAR) of 10 to 50. This is a lower SAR (higher content of Al) than has been previously used in comparable catalysts, such as those described in the examples of US2016/108330A1.

In a first aspect the invention relates to an acid condensation catalyst comprising:
a zeolite having a pore size of 10 tetrahedral atoms, a porosity of ≥0.05 mL/g in the range of 20-100 Å, and a silica: alumina ratio (SAR) of 10 to 50;
an alumina binder in which the zeolite is dispersed; and at least one metal;
wherein the acid condensation catalyst has a porosity of ≥0.06 mL/g in the range of 20-100 Å as measured by physisorption using the BJH method.

In a second aspect the invention relates to a method of manufacturing an acid condensation catalyst, comprising the steps of:
(i) combining a zeolite having a pore size of 10 tetrahedral atoms, a silica: alumina ratio (SAR) of 10 to 50, and having a porosity of ≥0.05 mL/g in the range of 20-100 Å, as measured by physisorption using the BJH method, with an alumina binder precursor;
wherein the alumina binder precursor is peptized with acid either before or after combining with the zeolite;
(ii) forming the mixture into particles suitable for a fixed bed process;
(iii) calcining to convert the alumina binder precursor into aluminium oxide; and
   (iv) impregnating the product of step (iii) with a metal salt;
      wherein the catalyst is according to the first aspect.

In a third aspect the invention relates to a method of carrying out acid condensation on a feed stream, where that the method is carried out in the presence of a catalyst according to the first aspect.

### BRIEF DESCRIPTION OF THE DRAWINGS

FIG. 1 illustrates the specific productivity and coke yield of the examples and comparative examples.

### DETAILED DESCRIPTION

Any sub-headings are included for convenience only and are not to be construed as limiting the disclosure in any way.

### Acid Condensation Catalyst

As mentioned previously, US2016/108330 Å1 provides examples in which a Ni- or Ga-doped Al₂O₃-bound ZSM-5 (catalysts LL and MM of Table 12) are used as the catalyst in the acid condensation step. The origin of the alumina or ZSM-5 is not reported in those examples, although in Example 52 a ZSM-5 zeolite is used which is the material CBV 8014 from Zeolyst International with a silica to alumina ratio (SAR) of 80.

Zeolites are commonly classified by the number of tetrahedral atoms (Si or Al) that define the pore openings. In the present invention, the zeolite is one in which the pore size is 10 tetrahedral atoms. This pore size has been found to be particularly appropriate for the generation of fuel and xylenes. The zeolite is preferably a zeolite having the MFI framework. Most preferably the zeolite is ZSM-5, because it provides a high yield of aromatic products and is resistant to deactivation. In each case it is preferred that the zeolite is in the hydrogen form.

The zeolite has a framework which may be counterbalanced by cations, such as ammonium cations and/or protons. Preferably, the zeolite is in the hydrogen form.

To ensure that the catalyst does not deactivate too quickly, the zeolite has a SAR of 10 to 50. It is preferred that the zeolite has a SAR in the range of 10 to 40, more preferably in the range of 20 to 40.

It has been established by the present inventors that the pore size distribution of the catalyst plays an important role in providing a catalyst with an advantageous balance between productivity and coke yield. Porosity in the catalyst arises from a mixture of porosity associated with the zeolite and the alumina binder.

Pore sizes of 20-100 Å correspond to small mesopores (mesopores are defined as pores having diameters of 20-500 Å). A zeolite having a porosity of ≥0.05 mL/g in the range of 20-100 Å has sufficient pore sizes to allow feed molecules to approach the active sites and to leave the zeolite, without the molecules getting stuck and forming coke. It is preferred that the zeolite has a porosity of 0.05 to 0.15 mL/g_{zeolite} in the range of 20-100 Å, preferably 0.05 to 0.10 mL/g_{zeolite}, such as 0.05 to 0.08 mL/g_{zeolite}.

Porosity may be measured using either N₂ or Ar as adsorbent by the BJH method. Similar values are obtained for the pore volume regardless of which gas is used. It preferred that the porosity is measured by Ar physisorption using the BJH method.

The zeolite may also include porosity associated with pore sizes of 100-1000 Å which encompasses both mesopores and macropores. It is preferred that the zeolite has a porosity of 0.05 to 1.0 mL/g_{zeolite} in the range of 100-1000 Å, preferably 0.05 to 0.50 mL/g_{zeolite}, preferably 0.05 to 0.40 mL/g_{zeolite}.

A wide variety of zeolites are commercially available with different pore size distributions. The pore size distribution may be the result of the route used to manufacture the zeolite. Alternatively, the zeolite may be modified to introduce porosity by methods known to those skilled in the art, for example by treatment with a base solution, or by hydrothermal ageing with steam at elevated temperature.

The content of zeolite based on the weight of the catalyst as a whole is preferably 60 to 95 wt %, more preferably 60 to 90 wt %, with a content of 70 to 85 wt % being most preferred.

The content of alumina in the catalyst is preferably 5 to 40 wt %, more preferably 10 to 40 wt %, with a content of 10-30 wt % being most preferred. In a preferred embodiment the alumina is γ alumina.

The weight ratio of zeolite: alumina in the catalyst is preferably 60:40 to 95:5, more preferably 60:40 to 90:10, with a ratio of 70:30 to 90:10 being most preferred.

The catalyst is doped with one or more metals. Preferred metals are transition metals and lanthanide metals. It is particularly preferred that the catalyst is doped with nickel. It is preferred that the metal, preferably nickel, is present in an amount which is sufficient to associate with the acid sites on the zeolite, but is not present in an amount in excess of this. A preferred nickel content is 0.1-5 wt % based on the total weight of the catalyst, preferably 0.5-2 wt %. Unlike the metal phosphide-containing catalysts described in US2022/203343 Å1, it is preferred that the metal is not present as a metal phosphide.

Porosity from the zeolite and the alumina contributes to the overall porosity of the catalyst. The acid condensation catalyst has a porosity of ≥0.06 mL/g_{catalyst} in the range of 20-100 Å, preferably 0.09 mL/g_{catalyst}. It is preferred that the acid condensation catalyst has a porosity of 0.06 to 0.30 mL/g_{catalyst} in the range of 20-100 Å, preferably 0.06 to 0.20 mL/g_{catalyst}, such as 0.06 to 0.15 mL/g_{catalyst}. It is particularly preferred that the acid condensation catalyst has a porosity of 0.09 to 0.30 mL/g_{catalyst} in the range of 20-100 Å, preferably 0.09 to 0.20 mL/g_{catalyst}, such as 0.09 to 0.15 mL/g_{catalyst}.

The catalyst may also include porosity in the 100-1000 Å range which encompasses both mesopores and macropores. It is preferred that the catalyst has a porosity of 0.05 to 1.0 mL/g_{catalyst} in the range of 100-1000 Å, such as 0.05 to 0.50 mL/g_{catalyst}. Higher porosity in this range seems to be associated with increased productivity (see Example 1), therefore it is preferred that the catalyst has a porosity of such as 0.20 to 0.50 mL/g_{catalyst}.

### Manufacture of the Catalyst

The first step (step (i)) in manufacturing the catalyst involves combining a zeolite with an alumina binder precursor. The properties of the zeolite used as the input material to form the catalyst were described under the “Acid condensation catalyst” heading. The alumina binder precursor is referred to herein as a “precursor” because it is peptized either before or after being combined with the zeolite in order to break the alumina down into smaller alumina crystals and thereby allow it to more effectively bind the zeolite. Peptization is preferably achieved by treating the alumina with an aqueous acid, preferably an aqueous monoprotic acid. Preferred acids include nitric acid, formic acid and acetic acid. While the alumina binder precursor may include any suitable form of alumina, boehmite is preferred.

In a preferred embodiment the zeolite and alumina binder precursor are combined by kneading. Kneading helps to achieve a uniform dispersion of the zeolite in the alumina. Kneading is preferably carried out in the presence of an aqueous phase to aid with mixing and, in the case where aqueous acid is used, additionally to peptize the alumina. A binder (not to be confused with the alumina binder precursor) may also be added during kneading to provide the particles with some strength. The binder may act to change the rheology of the mixture to aid in extrusion. The binder may be an organic binder which is burnt off in the subsequent calcination step. The binder if preferably a cellulose, preferably is hydroxyethyl cellulose. Alternatively, the binder may be an inorganic binder, such as silica, alumina chlorhydrate or kaolin phosphate. Kneading may be carried out at low temperatures or at elevated temperatures, e.g. above 50° C., typically above 80° C., such as above 100° C.

The porosity of zeolite and the alumina binder precursor contribute to the porosity of the catalyst. The alumina binder precursor can therefore be used to introduce additional porosity in the 20-100 Å and/or 100-1000 Å ranges. In some embodiments a single alumina binder precursor may be used. In alternative embodiments, two or more different alumina binder precursors may be used. The skilled person will be able to select appropriate alumina binder precursor(s) given the targeted pore size distribution in the end catalyst and with knowledge of the pore size distribution of the zeolite.

The mixture of zeolite, alumina and optionally binder are then formed into particles suitable for a fixed bed process (step (ii)). The product of this step may be referred to as a green body. Preferred types of particles include pellets, granules or extrudates. Appropriate forming techniques will be known to those skilled in the art. In a preferred embodiment the forming step involves extruding the mixture to form extrudates, preferably to produce a cylinder or multi-lobed extrudate. The particle diameter and shape may be adjusted based on the size of the reactor and pressure drop requirements.

The green body is then calcined (step (iii)). Calcination drives off any water remaining in the green body, burns off any binder which has been included, and causes the alumina particles to sinter which provides strength to the particles of catalyst. Calcination conditions will readily be determined by those skilled in the art. Typical conditions are a temperature of at least 500° C. for at least 1 hour. Calcination at about 600° C. for about 2 hours is generally appropriate. The calcination may also cause a phase change in the alumina, e.g. by converting boehmite into γ-alumina.

The product of step (iii) is then impregnated with one or more metals (step (iv)). Preferred metals include transition metals and lanthanide metals. It is particularly preferred that the particles are doped with nickel. Doping of the particles may be achieved using an aqueous solution comprising a salt of the required metal, for instance by incipient wetness impregnation or by ion exchange. It is particularly preferred that the particles are doped with nickel using a solution comprising a nickel salt, preferably by incipient wetness impregnation or by ion exchange.

Following doping of the particles it is generally necessary to carry out a drying step and optionally a further calcination step. Appropriate conditions will readily be determined by those skilled in the art.

### Use of the Catalyst

The catalysts described herein find particular utility as catalysts for converting a feed stream containing oxygenated hydrocarbons “oxygenates” into products with a higher number of carbon atoms per molecule.

As used herein the term “oxygenates” refers to hydrocarbons having one or more carbon atoms and at least one oxygen atom (referred to herein as C₁₊O₁₊ hydrocarbons). Preferably an oxygenate containing n carbon atoms contains between 1 to n oxygen atoms (CₙO₁₋ₙ). In a preferred embodiment the oxygenate contains 1 to 12 carbon atoms, preferably 1 to 6 carbon atoms. In preferred embodiments the oxygenated hydrocarbon has a ratio of carbon atoms: oxygen atoms of 0.5:1.0 to 1.5:1.0, such as 0.75:1.0 to 0.75 to 1.5:1.0, such as 0.75:1.0 to 1.25:1.0.

Exemplary oxygenates and process conditions applicable to the AC reaction are those described in US2016/0108330 Å (Virent Inc.), the disclosure of which is incorporated herein by reference.

Non-limiting examples of preferred oxygenates include monosaccharides, disaccharides, polysaccharides, ethers, sugars, sugar alcohols, alditols, ethanediol, ethanedione, acetic acid, propanol, propanediol, propionic acid, glycerol, glyceraldehyde, dihydroxyacetone, lactic acid, pyruvic aid, malonic acid, butanediols, butanoic acid, aldotetroses, tautaric acid, aldopentoses, aldohexoses, ketotetroses, ketopentoses, ketohexoses, alditols, hemicelluloses, cellulosic derivatives, lignocellulosic derivatives, starches and polyols. As is described in US2016/0108330A, particularly paragraphs [0093]-[0102] thereof, it is sometimes preferable to convert the oxygenated hydrocarbon into another oxygenated hydrocarbon which can be more readily processed by the AC catalyst, especially via hydrogenation.

Preferred oxygenates as substrates for the AC reaction include an alcohol, a ketone, an aldehyde, a furan, a diol, a triol, a hydroxy carboxylic acid or a carboxylic acid. Particularly preferred substrates include those selected from the group consisting of: methanol, ethanol, n-propyl alcohol, isopropyl alcohol, butyl alcohol, pentanol, hexanol, cyclopentanol, cyclohexanol, 2-methylcyclopentanol, hydroxyketones, cyclic ketones, acetone, propanone, butanone, pentanone, hexanone, 2-methyl-cyclopentanone, ethylene glycol, 1,3-propanediol, propylene glycol, butanediol, pentanediol, hexanediol, methylglyoxal, butanedione, pentanedione, diketohexane, hydroxyaldehydes, acetaldehyde, propionaldehyde, butyraldehyde, pentanal, hexanal, formic acid, acetic acid, propionic acid, butanoic acid, pentanoic acid, hexanoic acid, lactic acid, glycerol, furan, tetrahydrofuran, dihydrofuran, 2-furan methanol, 2-methyl-tetrahydrofuran, 2,5-dimethyl-tetrahydrofuran, 2-ethyl-tetrahydrofuran, 2-methyl furan, 2,5-dimethyl furan, 2-ethyl furan, hydroxylmethylfurfural, 3-hydroxytetrahydrofuran, tetrahydro-3-furanol, 5-hydroxymethyl-2(5H)-furanone, dihydro-5-(hydroxymethyl)-2(3H)-furanone, tetrahydro-2-furoic acid, dihydro-5-(hydroxymethyl)-2(3H)-furanone, tetrahydrofurfuryl alcohol, 1-(2-furyl)ethanol, and hydroxymethyltetrahydrofurfural, isomers thereof, or combinations thereof. In yet another exemplary embodiment, the oxygenate further comprises recycled C1+O1-3 hydrocarbon.

The product of the AC reaction is a compound containing 4 or more carbon atoms (C4+). The product is preferably a C4+ alcohol, a C4+ ketone, a C4+ alkane, a C4+ alkene, a C5+ cycloalkane, a C5+ cycloalkene, an aryl compound, a fused aryl compound, or a mixture thereof.

### Examples

The invention will now be illustrated by the following non-limiting examples.

### Test Methods

### BJH Measurement

Complete isotherms (using either Ar or N₂) at 77 K were measured on catalyst and zeolite samples ranging in pressure p/p0 from about 0.000001 to 0.995. Barrett-Joyner-Halenda (BJH) Pore Size and Volume Analysis was conducted using the analysis software package called MicroActive Version 5.01 from Micromeritics. The thickness curve model was selected as Harkins and Jura and the adsorption branch of the isotherm was typically used to avoid data disruption from the closure of the hysteresis loop at p/p0=0.42.

### General Procedure for Manufacturing Catalysts

The alumina was placed in the mixing bowl of a paddle style mixer along with a slight excess weight of DI water and the solid was mixed for approximately 5 minutes. The zeolite was added to the wetted solids and the mixture was mixed for a further 5 minutes. The wetted solids were transferred to a commercial kneader with a jacketed bowl. An organic binder (hydroxyethyl cellulose) was added and the solids were mixed for a brief period. The heater supplying oil to the jacketed kneader bowl was turned on and set to a temperature of 125° C. After the solids were combined an aqueous solution of nitric acid (approx. 0.1 mol HNO₃ per mol of Al₂O₃). was added to the mixer. The solids were mixed and DI water was added as needed. The slurry was mixed until a consistency representative of an extrudable mass was obtained. The solid was extruded in a 2″ OD ram style extruder equipped with four 1.8 mm diameter openings. The resulting green bodies were calcined at 600° C. for a period of 2 hours.

The calcined materials were doped with nickel as follows. The liquid water uptake was measured on a small sample of the dry support, to determine the water uptake (g_{water}/gₛᵤₚₚₒᵣₜ). An aqueous solution of nickel nitrate, having a volume equal to the water uptake volume of the catalyst support, was added to the support with mixing. The solid was then dried and calcined at 400° C. The amount of nickel nitrate in the solution was chosen so that the Ni content would be equivalent to 1.0 wt % of the catalyst after drying and calcination.

### Materials

Various ZSM-5 samples were trialled which had the properties listed in Table 1.

TABLE 1

| | Z1 | Z2 | Z3 | Z4 |
|---|---|---|---|---|
| SAR | 34 | 30 | 28 | 30 |
| Pore volume | 0.086 | 0.030 | 0.079 | 0.052 |
| BJH 20-100 Å | | | | |
| mL/g_{zeolite} | | | | |
| Pore volume | 0.35 | 0.047 | 0.072 | 0.057 |
| (BJH 100-1000 Å) | | | | |
| mL/g_{zeolite} | | | | |

Z1 was manufactured as follows. Sodium aluminate (175 g) and NaOH (225 g) were dissolved in 4 L water. Separately, tetrapropyl ammonium bromide (1085 g) was dissolved in 4 L water. The solutions were combined and allowed to mix. LUDOX™ silica (6398 g) was placed in an autoclave and the combined solutions were transferred to the autoclave, with stirring. The autoclave was pressurized with N₂ (20-25 psi) and then heated up to 170° C. over 90 mins, held at 170° C. for 14 hours, then allowed to cool. The material was removed from the autoclave and washed until the conductivity of the wash water was <500 μS. The filter cake was dried in an oven overnight and then broken down using a pestle and mortar into a fine powder. The powder was then calcined (ramp 2° C./min up to 110° C., then ramp 5° C./min up to 450° C., hold for 16 hours, then ramp 5° C./min up to 550° C., hold for 16 hours). After crystallization the zeolite was washed and ion exchanged to remove sodium.

Z2 was manufactured as follows. About 42 kg of water was added to a tank, followed by 280 grams of tetrapropyl ammonium bromide as a template. To the tank with water and TPABr, 72 kg of waterglass (28.9 wt % SiO₂, 8.9 wt % Na₂O), 12.5 kg of aluminum sulfate (8.2% Al₂O₃), and 4.45 kg of sulfuric acid (93%) were simultaneously added maintaining pH of about 9.5. After all the raw materials were added, the gel was then transferred to reactor and hydrothermally crystallized at high temperature (˜160° C.) until zeolite relative crystallinity reached 95% or higher. After crystallization the zeolite was washed and ion exchanged to remove sodium.

Z3 was the commercial material PTF from Hejia Chemical.

Z4 was the commercial material CBV 3024E from Zeolyst International.

Various alumina samples were trialled which had the properties listed in Table 2.

TABLE 2

| | Alumina 1 | Alumina 2 | Alumina 3 |
|---|---|---|---|
| Pore volume | 0.42 | 0.29 | 0.046 |
| BJH 20-100 Å | | | |
| mL/gₐₗᵤₘᵢₙₐ | | | |
| Pore volume | 0.11 | 0.71 | 0.17 |
| BJH 100-1000 Å | | | |
| mL/gₐₗᵤₘᵢₙₐ | | | |

Alumina 1 was CATAPAL A from Sasol.
Alumina 2 was Veral™ alumina V-250 from UOP.
Alumina 3 was PURAL 200 from Sasol.

Catalysts were prepared following the general procedure and had the properties set out in Table 3.

TABLE 3

| | | | | | Pore volume | Pore volume |
|---|---|---|---|---|---|---|
| | | | Zeolite:alumina | Ni | 20-100 Å | 100-1000 Å |
| Catalyst | Zeolite | Alumina | ratio (w/w) | (wt %) | (mL/g_{catalyst}) | (mL/g_{catalyst}) |
| C1 | Z1 | A2 | 80:20 | 1 | 0.07 | 0.38 |
| C2* | Z2 | A2 | 80:20 | 1 | 0.14 | 0.12 |
| C3 | Z3 | A2 | 80:20 | 1 | 0.13 | 0.12 |
| C4 | Z3 | A1 + A2 | 85:15 | 1 | 0.06 | 0.17 |
| C5 | Z3 | A1 | 80:20 | 1 | 0.09 | 0.16 |
| C6* | Z4 | A3 | 80:20 | 1 | 0.05 | 0.12 |
| C7* | Z4 | — | 100:0 | 1 | 0.04 | 0.06 |
| C8* | Z4 | A3 | 60:40 | 0.75 | 0.01 | 0.28 |
| C9 | Z4 | A2 | 85:15 | 1 | 0.09 | 0.09 |
| C10 | Z4 | A1 | 80:20 | 1 | 0.13 | 0.06 |

*Not according to the invention

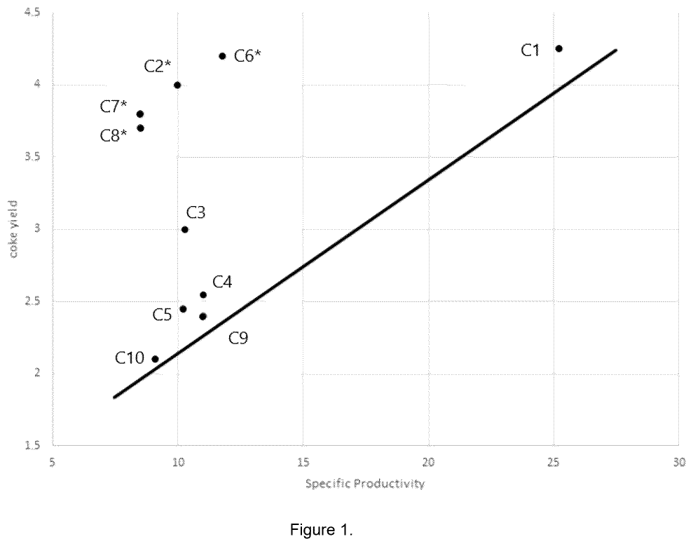

FIG. 1 illustrates relative coke yield vs. relative specific catalysts for Catalysts C1 to C10. There is a limit which is drawn in and labelled as the coke× productivity performance line, which is an indication that at least part of the coke is due to molecules that are inherent in the feed. The target is a catalyst which sits as close to the coke× productivity line and which has a productivity as high as possible. Catalysts C1, C3, C4, C5, C9 and C10 lie close to the coke/productivity performance line.

Catalysts C6, C7 and C8, having low porosity in the 20-100 Å range, i.e. ≤0.06 mL/g, sit off the coke× productivity line. It is thought that the low mesoporosity in these materials means that the feed molecules get stuck and turn to coke.

While 02 had comparable overall porosity in the 20-100 Å range compared to catalysts sitting on the coke× productivity line, the zeolite (Z2) used in this catalyst had a porosity of 0.03 mL/g in the 20-100 Å range. This demonstrates that the zeolite must itself have a sufficiently high porosity in the 20-100 Å range to allow feed molecules to enter and exit.

1. An acid condensation catalyst comprising:
a zeolite having a pore size of 10 tetrahedral atoms, a porosity of ≥0.05 mL/g_{zeolite} in the range of 20-100 Å, and a silica: alumina ratio (SAR) of 10 to 50;
an alumina binder in which the zeolite is dispersed; and
at least one metal;
wherein the acid condensation catalyst has a porosity of ≥0.06 mL/g_{catalyst} in the range of 20-100 Å as measured by physisorption using the BJH method.

2. A catalyst according to claim 1, wherein the catalyst has a porosity of 0.06 to 0.30 mL/g_{catalyst} in the range of 20-100 Å.

3. A catalyst according to claim 1, wherein the catalyst has a porosity of ≥0.09 mL/g_{catalyst} in the range of 20-100 Å as measured by physisorption using the BJH method.

4. A catalyst according to claim 3, wherein the catalyst has a porosity of 0.09 to 0.30 mL/g_{catalyst} in the range of 20-100 Å as measured by physisorption using the BJH method.

5. A catalyst according to any of claims 1 to 4, wherein the catalyst has a porosity of 0.05 to 1.0 mL/g_{catalyst} in the range of 100-1000 Å.

6. A catalyst according to any of claims 1 to 4, wherein the catalyst has a porosity of 0.20 to 0.50 mL/g_{catalyst} in the range of 100-1000 Å.

7. A catalyst according to any of claims 1 to 6, wherein the catalyst is in the form of pellets, granules or extrudates.

8. A catalyst according to any of claims 1 to 7, wherein the zeolite has a SAR in the range of 20 to 40.

9. A catalyst according to any of claims 1 to 8, wherein the zeolite has the ZSM-5 framework.

10. A catalyst according to any of claims 1 to 9, wherein the content of alumina is 5 to 40 wt % based on the weight of the catalyst as a whole.

11. A catalyst according to any of claims 1 to 10, wherein the content of zeolite is 60 to 95 wt % based on the weight of the catalyst as a whole.

12. A catalyst according to any of claims 1 to 11, wherein the metal is nickel.

13. A catalyst according to claim 10, wherein the nickel content is 0.1-5 wt % based on the weight of the catalyst as a whole.

14. A catalyst according to claim 10, wherein the nickel content is 0.5-2 wt % based on the weight of the catalyst as a whole.

15. A catalyst according to any of claims 1 to 14, wherein the metal is not present as a metal phosphide.

16. A catalyst according to any of claims 1 to 15, wherein the catalyst comprises:
a zeolite having the ZSM-5 framework, a porosity of ≥0.05 mL/g_{zeolite} in the range of 20-100 Å, and a silica: alumina ratio (SAR) of 10 to 50, in an amount corresponding to 60-95 wt % based on the weight of the catalyst as a whole;
an alumina binder in which the zeolite is dispersed, in an amount corresponding to 5-40 wt % based on the weight of the catalyst as a whole; and
0.1-5 wt % nickel based on the weight of the catalyst as a whole; and wherein the acid condensation catalyst has a porosity of ≥0.06 mL/g_{catalyst} in the range of 20-100 Å as measured by physisorption using the BJH method.

17. A method of manufacturing an acid condensation catalyst, comprising the steps of:
(i) combining a zeolite having a pore size of 10 tetrahedral atoms, a silica: alumina ratio (SAR) of 10 to 50, and having a porosity of ≥0.05 mL/g in the range of 20-100 Å, as measured by physisorption using the BJH method, with an alumina binder precursor;
wherein the alumina binder precursor is peptized with acid either before or after combining with the zeolite;
(ii) forming the mixture into particles suitable for a fixed bed process;
(iii) calcining to convert the alumina binder precursor into aluminium oxide; and
(iv) impregnating the product of step (iii) with a metal salt;
wherein the catalyst is as defined in any of claims 1 to 16.

18. A method according to claim 17, wherein the zeolite has a porosity of 0.05 to 0.15 mL/g in the range of 20-100 Å.

19. A method according to claim 17 or claim 18, wherein the alumina binder is peptized using a monoprotic acid.

20. A method according to any of claims 17 to 19, wherein the metal salt is a transition metal salt or a lanthanide metal salt.

21. A method according to any of claims 17 to 20, wherein the metal salt is a nickel salt.

22. A method as claimed in any of claims 17 to 21, wherein the particles are in the form of pellets, granules or extrudates.

23. A process of carrying out acid condensation on a feed stream comprising one or more oxygenated compounds, where that the method is carried out in the presence of a catalyst according to any of claims 1 to 16.
